(19) United States
(12) Patent Application Publication
(10) Pub. No.: US 2021/0182844 A1
(43) Pub. Date: Jun. 17, 2021

(54) PROXIMITY COUPON DISTRIBUTION SYSTEM

(71) Applicant: Charles Isgar, Scottsdale, AZ (US)

(72) Inventor: Charles Isgar, Scottsdale, AZ (US)

(21) Appl. No.: 17/120,528

(22) Filed: Dec. 14, 2020

Related U.S. Application Data
(60) Provisional application No. 62/948,178, filed on Dec. 13, 2019.

(51) Int. Cl. G06Q 20/38; G06Q 20/32; G06Q 30/02

(52) U.S. Cl. CPC G06Q 20/387; G06Q 30/0235; G06Q 20/3224

(57) ABSTRACT

A proximity coupon donation system is provided. The system includes a computer server having a memory storing business data and user data, a business computing device coupled to the computer server, and a user computing device coupled to the computer server. The computer server may be programmed to receive from the business computing device a signal to activate real-time coupon distribution and automatically establish a proximity zone around the business computing device. The server may further be programmed to receive a signal from a user computing device that the user computing device is within the proximity zone and automatically establish a connection between the server and the user computing device. Further, the server may be programmed to automatically generate and send for display on the user computing device a real-time coupon associated with the business operating the business computing device.

### CROSS REFERENCE TO RELATED APPLICATION

This invention claims priority to U.S. provisional patent application Ser. No. 62/948,178, filed Dec. 13, 2019, entitled “Proximity Coupon Distribution System,” which is incorporated entirely herein by reference.

### BACKGROUND OF THE INVENTION

### Technical Field

This invention relates generally to a coupon distribution system, and more particularly to a system for distributing digital coupons to consumers within proximity to a business.

### State of the Art

Businesses are consistently looking for opportunities to market to consumers. Often businesses market to consumers that fit a certain demographic, such as previous purchases, live in a certain area, are a certain age and the like. Further, businesses also advertise to consumers that are passing by through the use of signs, banners, and the like. Further, most businesses have a desire to bring in consumers during times when the typical and historical customers are lower. There lacks a system that can address all of these issues in a single system.

Accordingly, there is a need for an improved coupon distribution system based on proximity of the consumer that utilizes mobile computing, which is popular and now an important platform for communicating with customers. A system that provides real-time advertising while also allowing smaller businesses, that cannot afford regional or national campaigns, to engage in promotions.

### DISCLOSURE OF THE INVENTION

The present invention relates to a proximity coupon distribution system that allows businesses to distribute real-time digital coupons to consumers within proximity to the businesses.

An embodiment includes a proximity coupon distribution system comprising: a computer server having a memory storing business data and user data; a business computing device coupled to the computer server; and a user computing device coupled to the computer server, the computer server programmed to: receive from the business computing device a signal to activate real-time coupon distribution and automatically generate and send for auto-execution instructions to establish a proximity zone around the business computing device; receive a signal from a user computing device that the user computing device is within the proximity zone; automatically establish a connection between the server and the user computing device in response to receiving the signal from the user computing device that the user computing device is within the proximity zone; and automatically generate and send for display on the user computing device a real-time coupon associated with the business operating the business computing device.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is a diagrammatic view of a proximity coupon distribution system in accordance with an embodiment;

FIG. 2 is a perspective view of a proximity coupon distribution system in accordance with an embodiment;

FIG. 3A is a view of a user computing device operating as part of a proximity coupon distribution system in accordance with an embodiment;

FIG. 3B is another view of a user computing device operating as part of a proximity coupon distribution system in accordance with an embodiment;

FIG. 4 is a view of a business computing device operating as part of a proximity coupon distribution system in accordance with an embodiment; and

FIG. 5 is a flow chart of programmed steps of a computer server of a proximity coupon distribution system in accordance with an embodiment.

### DETAILED DESCRIPTION OF EMBODIMENTS OF THE INVENTION

As discussed above, embodiments of the present invention relate to a proximity coupon distribution system that allows businesses to distribute real-time digital coupons to consumers within proximity to the businesses.

There are different forms of coupons, such as, without limitation, internet coupons, mobile coupons, mobile app coupons and the like.

A mobile coupon is an electronic ticket delivered to a mobile phone that can be exchanged for financial discount when purchasing products or services. Coupons may also be referred to as “coupon codes”, “promotional codes”, “promotion codes”, “discount codes”, “keycodes”, “promo codes”, “surplus codes”, “portable codes”, “shopping codes”, “voucher codes”, “reward codes”, “discount vouchers”, “referral codes” or “source codes”. A coupon can be in digital form distributed by the system for redemption (discounted value or discounted percentage) used at a point of sale.

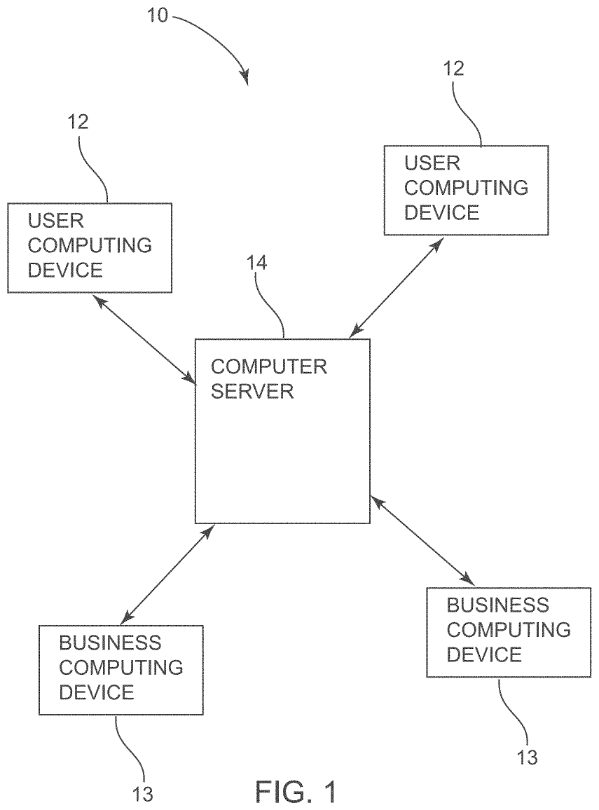

Referring to the drawings, FIG. 1 depicts an embodiment of a proximity coupon distribution system 10. The system 10 may include a user computing devices 12, a business computing device 13, and a computer server 14, wherein the user computing devices 12 and the business computing device 13 are coupled to the computer server 14. This coupling may be a network connection, such as through an Internet connection, wherein the user computing devices 12 and the business computing device 13 may communicate with and receive communication from the server 14. It will be understood that the connection between the user computing device 12 and the server 14 is separate and independent from the connection between the business computing device 13 and the server 14.

In embodiments, the collection device may be, without limitation, a smartphone or a tablet for electronic donations, or a container with smart electronics or with a smartphone or a tablet coupled to a container for operation within the system while also allowing for proper operation of the system 10. In embodiments where there is a tablet, smart phone or the like, the system 10 may include an application that operates on the devices 12 and 13 in order to communicate with the server 14.

The user computing devices and business computing device may be, without limitation, a smartphone, or a tablet. In embodiments where there is a tablet, smart phone or the like, the system 10 may include an application that operates on the devices 12 and 13 in order to communicate with the server 14.

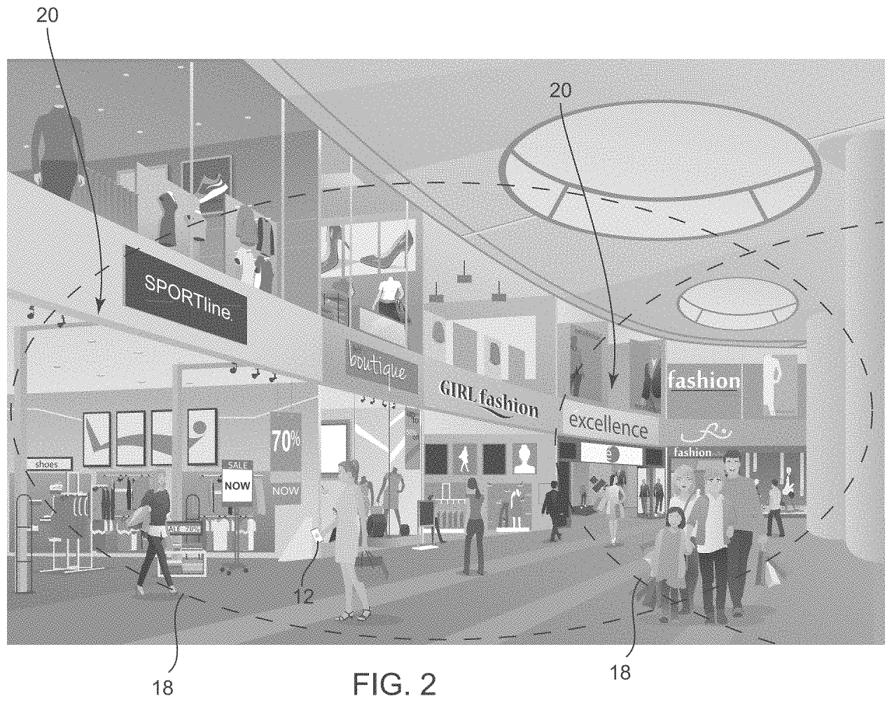

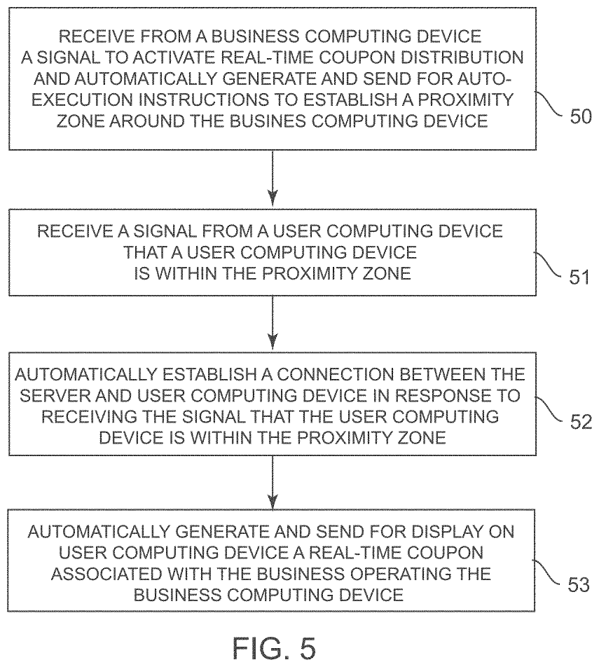

The computer server 14 may include a memory storing business data corresponding to various businesses and user data. The business data includes coupon information, business contact information and the like. The user data may include name, contact information including address, email and phone number and may include demographic information, and the like. A user computing device 12 and business computing device 13 may be coupled to the computer server 14, and, referring additionally to FIGS. 2 and 5, the computer server 14 may be programmed to receive from business computing device 13 a signal to activate real-time coupon distribution and automatically generate and send for auto-execution instructions to establish a proximity zone 18 around the business computing device 13 (Step 50); receive a signal from a user computing device 12 that the user computing device 12 is within the proximity zone 18 (Step 51); automatically establish a connection between the server and the user computing device in response to receiving the signal from the user computing device that the user computing device 12 is within the proximity zone 18 (Step 52); and automatically generate and send for display on the user computing device 12 a real-time coupon associated with the business operating the business computing device 13 (Step 53).

The proximity zone 18 may be a predetermined size, such as a radius or space around the business computing device 13. The size of the proximity zone 18 may be determined by the type of business associated with the business computing device 13. The proximity zone 18 may include, but is not limited to a geofence, an NFC zone, a Wi-Fi signal quadrant, such as a 5G Wi-Fi signal quadrant, or another zone established by any other means of establishing a proximity zone.

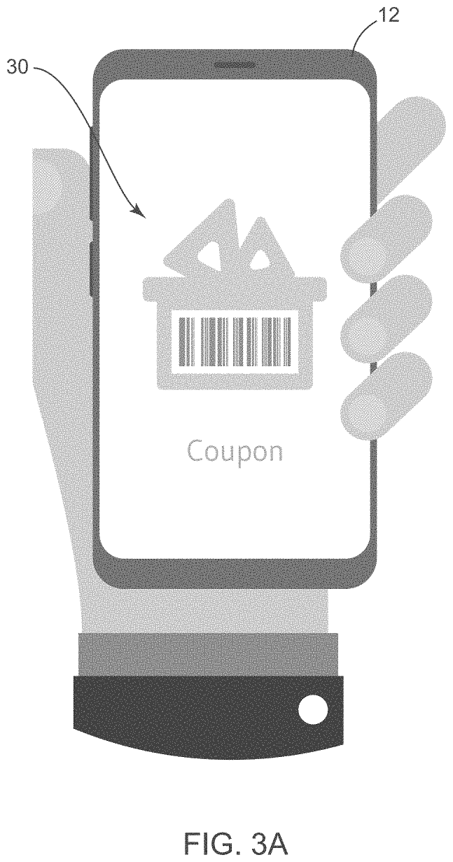

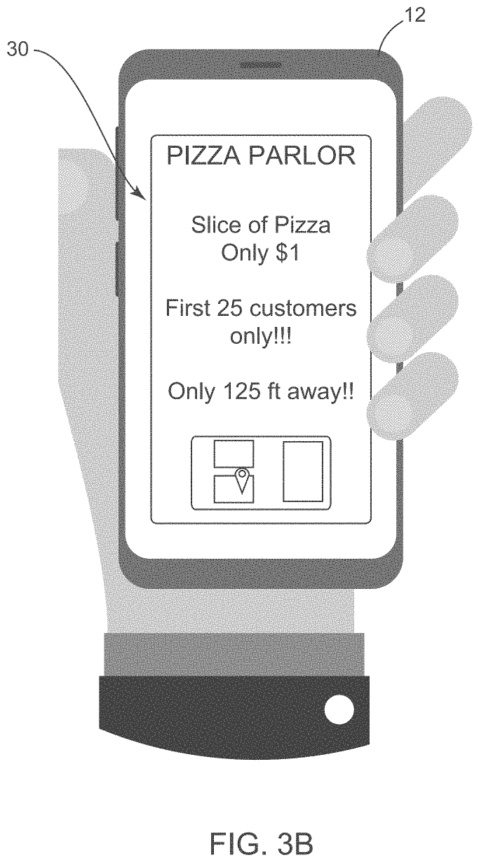

Referring again to the drawings, FIGS. 2-3B depict operation of a proximity coupon distribution system 10 in accordance with an embodiment. In embodiments, as the user computing device 12 enters the proximity zone 18 around the business computing device 13 that is within business 20 of a location such as a shopping mall or in other locations, as shown in FIG. 2, the user computing device 12 may be operating an application that allows for automatically sending a signal that the user computing device is within the proximity zone 18 when the user computing device 12 is within the proximity zone 18. Once the server 14 receives the signal that the user computing device 12 is within the proximity zone 18, the server 14 may send a coupon 30 to the user computing device 12 as a digital coupon 30 that is a real-time coupon sent from the business 20 to the user computing device 12 utilizing the system 10. The user may then claim the coupon 30 right away in the business 20. The coupon may be any one of various types of coupons as discussed above. For example, it may be a coupon with a scannable bar code as shown in FIG. 3A or it may be a discount presented for a certain period of time or number of customers, such as, but not limited to, pizza for $1 for the first 25 customers as shown in FIG. 3B. The system 10 may include, as also depicted in FIG. 3B, a location of the business that is displayed with respect to the user computing device 12, such as, without limitation, a distance from the business or a map or other form of navigation.

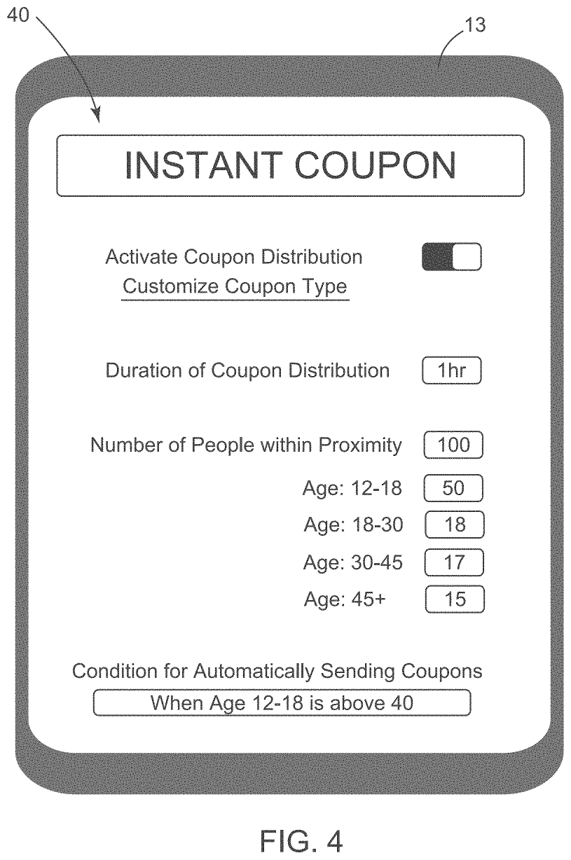

Referring again to the drawings, the business computing device 13 may operate an application that provides a business interface 40 as depicted in FIG. 4. The business interface may allow the business owner certain control over the operation of the proximity coupon distribution system 10 as it applies to the business 20. For example, the business interface 40 may provide the control of 1) turning on and off activation of the system 10 as it pertains to the business 20 associated with business device 13; 2) a duration of time to run the system 10 for the business 20; 3) a demographic of individuals to receive real-time coupons, such as, but not limited to age, gender, interests and the like; 4) setting a condition to automatically trigger real-time coupons (example: 25 high school students in proximity zone 18; 5) coupon type and times for valid use; and the like.

The business interface 40, in general, may operate to show how many people have user computing devices that are activated inside a specified proximity zone or other GPS zone that may be identified by the business through the business interface 40. The system may only share general demographics, as discussed above, of users that have been shared with user permission. The system may not track and share identifying information. Through the business interface 40, the business can put out an instant coupon with or without using the data, the instant or real-time coupon being sent from the server to the user computing device. This instant coupon is sent in real-time to capitalize on the population that is within an immediate purchasing area of the business. For example, and without limitation, the business may be a theater with many empty seats; the business may be a restaurant with fresh pizza that will not be good in two hours, or any goods that may be discounted or promoted for real-time targeting of consumers.

The benefits of a real-time proximity coupon distribution system 10 may include, but are not limited to the following:
a. Move perishable inventory;
b. Target specific groups of customers when the business has permissible demographic data of the group of customers;
c. Promote sales during slow periods to better utilize staff;
d. Save on paper flyers and other physical advertising that is done on location (green version of advertising);
e. Create fun and energy for customers on limited quantity and time deals;
f. Get customers in store to browse other goods;
g. Better efficiency of advertising to customers that are already nearby than general advertising;
h. Cell phone and portable devices are increasingly useful and accurate tools for utilizing coupons;
i. Can also guide a customer in a large store to find the deal that is promoted;
j. Acquire new customers;
k. Collect data on customers with users' permission for future coupons
l. Campaigns can be very specific to quantity of goods and users to push the coupon with time limits/quantity limits (until the goods are sold out);
m. Multiple campaigns can go on from one store;
n. Campaigns are launched from each store and are possible to be launched remotely if the store has a monitoring system but would still be store specific;
o. Campaigns can identify quantity of goods with limitations (first ten customers get a pizza for a dollar) (pizza for a dollar until sold out).

Embodiments may be available on or through the internet, such as through domain names reserved and owned by Applicant that include walkingcoupon.com, coupon-circle.com, zip-coupon.com, coupon-gps.com. dash-coupon.com, deal-gps.com or the like.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, cloud-based infrastructure architecture, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A proximity coupon distribution system comprising:
a computer server having a memory storing business data and user data;
a business computing device coupled to the computer server; and
a user computing device coupled to the computer server, the computer server programmed to:
receive from the business computing device a signal to activate real-time coupon distribution and automatically generate and send for auto-execution instructions to establish a proximity zone around the business computing device;
receive a signal from the user computing device that the user computing device is within the proximity zone;
automatically establish a connection between the computer server and the user computing device in response to receiving the signal from the user computing device that the user computing device is within the proximity zone; and
automatically generate and send for display on the user computing device a real-time coupon associated with the business operating the business computing device.

2. The proximity coupon distribution system of claim 1, wherein the business computing device operates an application that provides a business interface.

3. The proximity coupon distribution system of claim 2, comprising more than one user computing device.

4. The proximity coupon distribution system of claim 3, wherein the business interface shows how many of the user computing devices are activated in the proximity zone.

5. The proximity coupon distribution system of claim 1, wherein the proximity zone is a predetermined size.

6. The proximity coupon distribution system of claim 1, wherein the proximity zone predetermined size is determined by what business is associated with the business computing device.

7. The proximity coupon distribution system of claim 1, wherein the proximity zone comprises a geofence.

8. The proximity coupon distribution system of claim 1, wherein the proximity zone comprises an NFC zone.

9. The proximity coupon distribution system of claim 1, wherein the proximity zone comprises a Wi-Fi signal quadrant.

10. The proximity coupon distribution system of claim 1, wherein the business data comprises coupon information and/or business contact information.

11. The proximity coupon distribution system of claim 1, wherein the user data comprise contact information and/or demographic information.

12. The proximity coupon distribution system of claim 11, wherein the contact information comprises address, email and/or phone number.

13. The proximity coupon distribution system of claim 1, wherein the coupon is selected from the group consisting of an internet coupon, a mobile coupon, and/or a mobile app coupon.

14. The proximity coupon distribution system of claim 1, wherein the coupon comprises a scannable bar code.

15. The proximity coupon distribution system of claim 1, wherein the coupon is for a predetermined period of time.

16. The proximity coupon distribution system of claim 1, wherein the coupon is for a predetermined number of users.

17. The proximity coupon distribution system of claim 1, wherein the user computing device is a smartphone or tablet.

18. The proximity coupon distribution system of claim 1, wherein the business computing device is a smartphone or tablet.
